(19) United States
(12) Patent Application Publication
(10) Pub. No.: US 2016/0076655 A1
(43) Pub. Date: Mar. 17, 2016

(54) THROTTLE VALVE HAVING A PRESSURE RELIEF VALVE

(71) Applicant: INTERNATIONAL ENGINE INTELLECTUAL PROPERTY COMPANY, LLC, Lisle, IL (US)

(72) Inventors: Jon Alan Bigley, Bowling Green, KY (US); Oswald Baasch, Bowling Green, KY (US); Stefan Holder, Alvaton, KY (US); Mike Troyer, Bowling Green, KY (US)

(73) Assignee: International Engine Intellectual Property Company, LLC, Lisle, IL (US)

(21) Appl. No.: 14/786,910

(22) PCT Filed: Apr. 24, 2013
(86) PCT No.: PCT/US13/37885

§ 371 Date: Oct. 23, 2015

(51) Int. Cl. F16K 1/52; F02M 35/104; F16K 17/02; F01N 13/10

(52) U.S. Cl. CPC F16K 1/52; F01N 13/10; F02M 35/104; F16K 17/02

(57) ABSTRACT

A pressure relief valve is associated with a throttle valve to shunt flow around a throttle valve element which is selectively positionable to throttle flow through the throttle valve. In a presently disclosed embodiment, a throttle valve comprises a valve body circumscribing a main flow passage extending along a central longitudinal axis between an inlet and an outlet. A valve plate is disposed within the main flow passage for turning about an axis of turning which perpendicularly intersects the central longitudinal axis for selectively throttling flow through the main flow passage. A pressure relief mechanism is mounted on the valve body.

### TECHNICAL FIELD

This disclosure relates to a throttle valve having a pressure relief valve which can relieve pressure across the throttle valve when the throttle valve is throttling flow.

### BACKGROUND

An engine exhaust throttle valve is operable to throttle engine exhaust flow coming from an exhaust manifold of an internal combustion engine. Throttling of engine exhaust flow creates backpressure on the engine which is useful for various purposes such as decelerating an engine. The degree to which engine exhaust is being throttled can however potentially affect various engine-associated components in ways which are inappropriate. A pressure relief mechanism can relieve pressure across an engine exhaust throttle valve without re-adjusting the throttle valve.

### SUMMARY

In a presently disclosed embodiment, a throttle valve comprises a valve body circumscribing a main flow passage extending along a central longitudinal axis between an inlet and an outlet. A valve plate is disposed within the main flow passage for turning about an axis of turning which perpendicularly intersects the central longitudinal axis for selectively throttling flow through the main flow passage.

A pressure relief mechanism is mounted on the valve body and operable in response to pressure differential across the valve plate exceeding a differential pressure threshold to shunt flow which has entered the main flow passage at the inlet through a relief passage around the valve plate to the outlet.

A cover is disposed in covering relation to a surface zone on an exterior of the valve body and cooperates with the valve body to form an enclosure containing the surface zone. The cover has a continuous perimeter margin sealed to the valve body.

The relief passage comprises an entrance port extending from the main flow passage at a location upstream of the axis of turning through the valve body to the enclosure and an exit port extending from the enclosure through the valve body to the main flow passage at a location downstream of the axis of turning.

The pressure relief mechanism comprises a pressure relief element which is disposed within the enclosure and has a length comprising a first lengthwise end portion and a second lengthwise end portion, the first lengthwise end portion being closer to the inlet and the second lengthwise end portion being farther from the inlet.

A mounting mounts the first lengthwise end portion of the pressure relief element on the valve body at a location which associates the second lengthwise end portion of the pressure relief element with the entrance port for controlling flow through the relief passage as a function of pressure differential between pressure in the main flow passage at the entrance port and pressure in the main flow passage at the exit port.

The throttle valve is useful as a throttle valve in an engine intake or exhaust system.

The pressure relief mechanism can be embodied as a separate assembly.

The foregoing non-limiting summary is accompanied by further detail presented in the Detailed Description below with reference to the following drawings which illustrate a non-limiting embodiment.

### BRIEF DESCRIPTION OF THE DRAWINGS

FIG. 1 schematically shows a portion of an internal combustion engine having an exhaust throttle valve for selectively throttling engine exhaust.

FIG. 2 is a perspective view of an exhaust throttle valve by itself with a portion removed to illustrate a pressure relief mechanism.

FIG. 3 is an exploded perspective view of the exhaust throttle valve shown in FIG. 2 looking in a different direction.

FIG. 4 is an enlarged cross section view in the direction of arrows 4-4 in FIG. 2.

### DETAILED DESCRIPTION

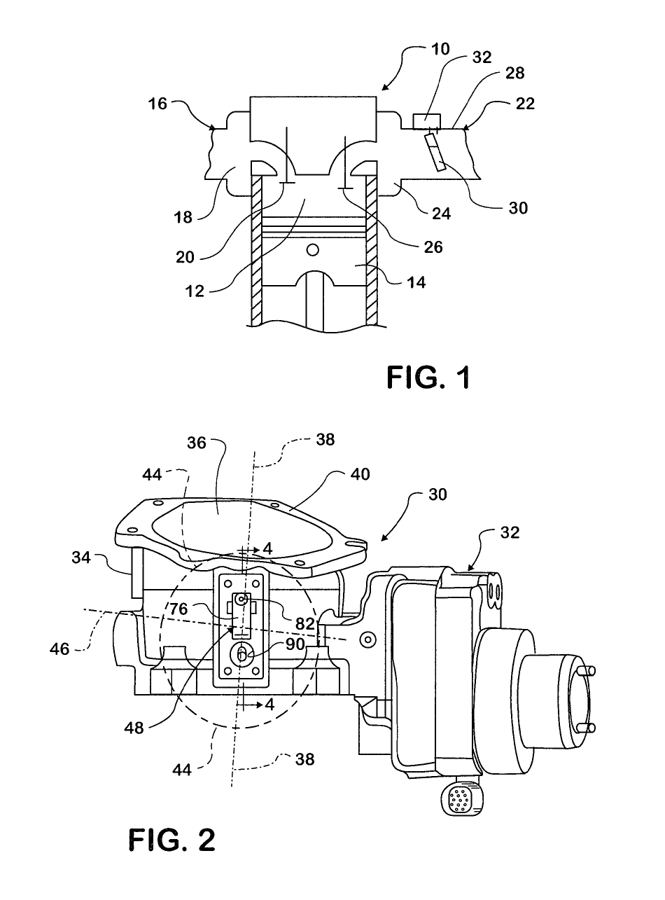

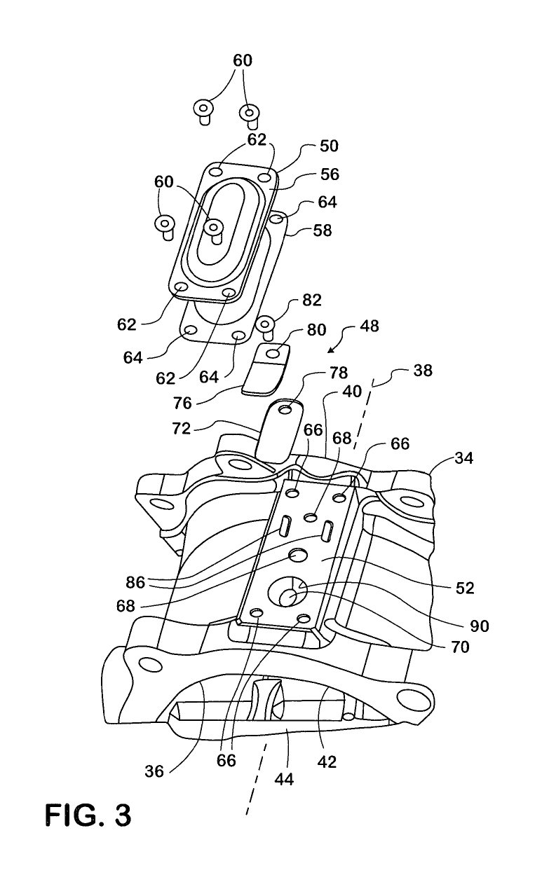

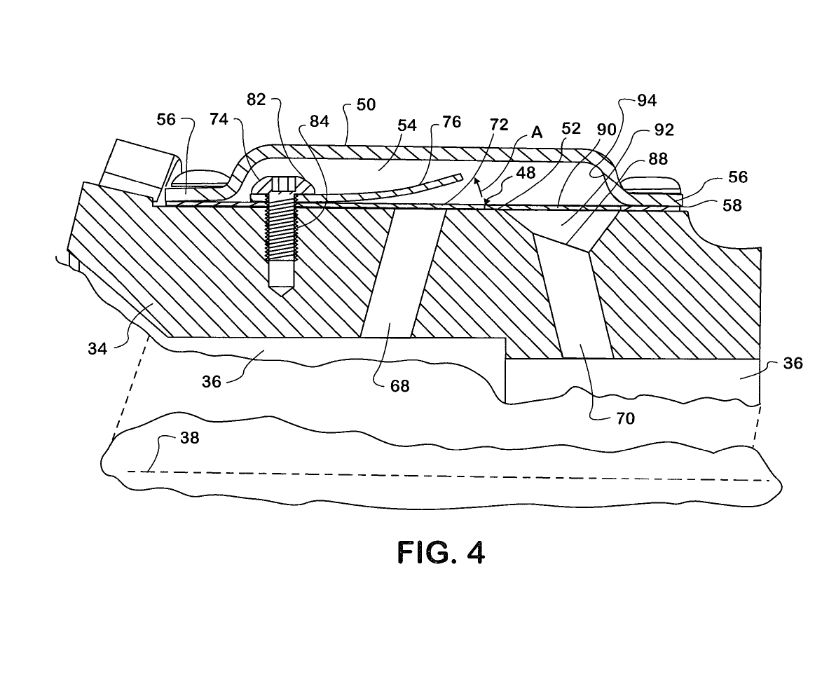

FIG. 1 shows an internal combustion engine 10 having multiple engine cylinders 12 (only one cylinder being shown in the Figure) within each of which a combustible mixture is ignited to reciprocate a piston 14 which is coupled to an output shaft (not shown) to deliver output torque to a load.

The combustible mixture comprises air which has entered engine cylinders 12 through an intake system 16 which comprises an intake manifold 18 through which air which has passed through intake system 16 enters an engine cylinder 12 when a cylinder intake valve 20 for that engine cylinder is open. The fuel component of the combustible mixture is introduced in any of various ways such as by direct injection for example.

Engine 10 also comprises an exhaust system 22 for conveying engine exhaust created by combustion of a mixture from engine cylinders 12. Exhaust system 22 comprises an exhaust manifold 24 into which engine exhaust from an engine cylinder 12 passes when a cylinder exhaust valve 26 for that engine cylinder is open. An exhaust passage 28 conveys engine exhaust from exhaust manifold 24 to a tailpipe (not shown). Various components which may be present in exhaust passage 28 are not shown with the exception of an exhaust throttle valve 30 which is operable by an actuator 32 to selectively throttle engine exhaust flow coming from exhaust manifold 24. At the location of exhaust throttle valve 30, exhaust passage 28 comprises an exhaust passage wall having a central longitudinal axis through which engine exhaust flows.

Exhaust throttle valve 30 comprises a valve body 34 assembled into exhaust passage 28 such that engine exhaust flows through a main flow passage 36 having a central longitudinal axis 38 extending between an inlet 40 and an outlet 42 of valve body 34. In this way valve body 34 becomes a portion of a wall circumscribing exhaust passage 38. A throttle valve element commonly called a valve plate, or a throttle plate, 44 is disposed within main flow passage 36 for turning about an axis of turning 46 which perpendicularly intersects central longitudinal axis 38 for selectively throttling engine exhaust flow through main flow passage 36.

A pressure relief mechanism 48 is mounted on valve body 34 and is operable in response to pressure differential between inlet 40 and outlet 42 when valve plate 44 is throttling flow through main flow passage 36 to shunt engine exhaust flow which has entered main flow passage 36 at inlet 40 through a relief passage around valve plate 44 to outlet 42.

A cover 50 is disposed in covering relation to a surface zone 52 on an exterior of valve body 34 and cooperates with surface zone 52 to form an enclosure 54. Cover 50 has a continuous perimeter margin 56 sealed to a continuous perimeter margin of surface zone 52. A gasket 58 which provides the seal is held sandwiched between perimeter margin 56 of cover 50 and the perimeter margin of surface zone 52 by four screws 60 each of which passes through aligned holes 62, 64 in perimeter margin 56 of cover 50 and gasket 58 respectively, and is threaded into a respective hole 66 in valve body 34.

The relief passage comprises an entrance port 68 from main flow passage 36 at a location upstream of axis of turning 46, through valve body 34 and surface zone 52, to enclosure 54 and an exit port 70 from enclosure 54, through surface zone 52 and valve body 34, to main flow passage 36 at a location downstream of axis of turning 46.

Pressure relief mechanism 48 comprises a pressure relief element 72 which has a length and comprises a first lengthwise end portion and a second lengthwise end portion. The first lengthwise end portion is closer to inlet 40 and the second lengthwise end portion is farther from inlet 40.

A mounting 74 mounts the first lengthwise end portion of pressure relief element 72 on valve body 34 at a location which associates the second lengthwise end portion of pressure relief element 72 with entrance port 68 for controlling engine exhaust flow through the relief passage as a function of pressure differential between pressure in main flow passage 36 at entrance port 68 and pressure in main flow passage 36 at exit port 70.

Pressure relief mechanism 48 causes pressure relief element 72 to close entrance port 68 to enclosure 54 when pressure differential between pressure in main flow passage 36 at inlet 40 and pressure in main flow passage 36 at outlet 42 is less than a pressure differential threshold and to open entrance port 68 to enclosure 54 when pressure differential between pressure in main flow passage 36 at entrance port 68 and pressure in main flow passage 36 at exit port 70 becomes at least as great as the pressure differential threshold.

Pressure relief element 72 comprises a spring steel blade which, when unstressed, assumes a flat, planar shape. Blade 72 has a length parallel with central longitudinal axis 38.

Mounting 74 comprises a cantilever mounting of blade 72 at the blade's first lengthwise end portion which places the blade's second lengthwise end portion flat against surface zone 52 of valve body 34 to close entrance port 68 to enclosure 54. Blade 72 resiliently flexes to open entrance port 68 to enclosure 54 when pressure differential between pressure in main flow passage 36 at entrance port 68 and pressure in main flow passage 36 at exit port 70 becomes at least as great as the pressure differential threshold.

A limiter 76 overlies blade 72 for limiting flexing of the blade. Blade 72 contains a hole 78 at the first lengthwise end. Limiter 76 has a first lengthwise end which is disposed against the first lengthwise end of blade 72 and which contains a hole 80 in registry with hole 78. A screw 82 has a head and a threaded shank which passes through holes 78, 80 to tightly engage a threaded hole 84 in valve body 34 and force the screw head against surface zone 52 thereby cantilever mounting blade 72 for flexing motion on valve body 34.

A locator on throttle body 34 within surface zone 52 is disposed between the cantilever mounting of blade 72 and entrance port 68 for locating a width of blade 72 on valve body 34. The locator comprises a pair of risers 86 on either side of blade 72 which are spaced apart slightly more than the blade width so as not to interfere with blade flexing.

Entrance port 68 slants toward enclosure 54 in a direction away from inlet 40. Exit port 70 slants away from enclosure 54 in a direction toward outlet 42.

Exit port 70 comprises a funnel 88 having an open mouth 90 at surface zone 52 and a narrowing taper 92 which extends away from surface zone 52 but ends before reaching main flow passage 36. A semi-circumference of narrowing taper 92 is closer to entrance port 68 and has a surface area which is smaller than the surface area of a semi-circumference of narrowing taper 92 which is farther from entrance port 68. Open mouth 90 circumscribes an area at surface zone 52 which is greater than an area circumscribed by entrance port 68 at surface zone 52.

Cover 50 has a wall surface 94 that surrounds the semi-circumference of open mouth 90 which is farther from entrance port 68. Wall surface 94 inclines in a direction away from surface zone 52 to overlie a portion of open mouth 90. This arrangement is useful in directing engine exhaust flow into exit port 70.

Materials used in the construction which has been described are selected for use in an environment where high exhaust temperatures will occur. The pressure differential threshold determines physical characteristics of certain elements such as blade 72.

The disclosed structure which provides pressure relief without having to re-adjust the throttle valve may be adapted to throttle valves other than the butterfly type which has been illustrated and described. Examples of such other throttle valves include poppet valves, spool valves, pressure-balanced valves, and flap valves. The entrance port of the pressure relief passage is open to the flow path being throttled at a location upstream of where the particular throttle valve element is throttling flow. The exit port of the pressure relief passage is open to the flow path being throttled at a location downstream of where the particular throttle valve element is throttling flow.

Adaptation of the pressure relief structure may include modification and/or addition of certain constructional features for making the pressure relief function temperature-dependent and/or for constructing and/or mounting the pressure relief element other than as the disclosed cantilever-mounted spring blade. Because the disclosed embodiment relies on the wall of the throttle body to cooperate with the cover to form the pressure relief enclosure, a self-contained embodiment can be constructed by using a separate base member to cooperate with the cover to form the pressure relief enclosure.

Regardless of the constructional details of any particular throttle valve which has an associated pressure relief corresponding to the one which has been illustrated and described, or modified as explained above, such a throttle valve is useful in applications not limited to an engine exhaust throttle valve.

When used as an engine exhaust throttle valve, the particular throttle valve may be placed at an exhaust port of a naturally aspirated engine, before or after the turbine of a single-stage turbo-charged engine, and before, in-between, or after stages of a multi-stage turbocharged engine. The particular throttle valve may be placed in association with an intake throttle in an engine intake system.

What is claimed is:

1. A throttle valve comprising:
a valve body circumscribing a main flow passage extending along a central longitudinal axis between an inlet and an outlet;
a throttle valve element positionable within the main flow passage for selectively throttling flow through the main flow passage;
a pressure relief mechanism mounted on the valve body and operable in response to pressure differential across the throttle valve element exceeding a differential pressure threshold to shunt flow which has entered the main flow passage at the inlet through a relief passage around the throttle valve element to the outlet;
a cover disposed in covering relation to a surface zone on an exterior of the valve body and cooperating with the surface zone to form an enclosure, the cover having a continuous perimeter margin sealed to a continuous perimeter margin of the surface zone;
the relief passage comprising an entrance port extending from the main flow passage at a location upstream of where the throttle valve element is throttling flow through the main flow passage, through the valve body and the surface zone, to the enclosure and an exit port extending from the enclosure, through the surface zone and the valve body, to the main flow passage at a location downstream of where the throttle valve element is throttle flow through the main flow passage;
the pressure relief mechanism comprising a pressure relief element which is disposed within the enclosure and has a length comprising a first lengthwise end portion and a second lengthwise end portion, the first lengthwise end portion being closer to the inlet and the second lengthwise end portion being farther from the inlet; and
a mounting which mounts the first lengthwise end portion of the pressure relief element on the surface zone at a location which associates the second lengthwise end portion of the pressure relief element with the entrance port for controlling flow through the relief passage as a function of pressure differential between pressure in the main flow passage at the entrance port and pressure in the main flow passage at the exit port.

2. The throttle valve as set forth in claim 1 in which the pressure relief mechanism causes the pressure relief element to close the entrance port to the enclosure when pressure differential between pressure in the main flow passage at the entrance port and pressure in the main flow passage at the exit port is less than a pressure differential threshold and to open the entrance port to the enclosure when pressure differential between pressure in the main flow passage at the entrance port and pressure in the main flow passage at the exit port becomes at least as great as the pressure differential threshold.

3. The throttle valve as set forth in claim 2 in which the pressure relief element comprises a spring steel blade which, when unstressed, assumes a flat, planar shape, and the mounting comprises a cantilever mounting of the blade at the first lengthwise end portion which places the second lengthwise end portion flat against the surface zone to close the entrance port when pressure differential between pressure in the main flow passage at the entrance port and pressure in the main flow passage at the exit port is less than the pressure differential threshold and which causes the blade to resiliently flex and open the entrance port to the enclosure when pressure differential between pressure in the main flow passage at the entrance port and pressure in the main flow passage at the exit port becomes at least as great as the pressure differential threshold.

4. The throttle valve as set forth in claim 3 including a limiter overlying the blade for limiting flexing of the blade.

5. The throttle valve as set forth in claim 4 including a locator on the surface zone disposed between the cantilever mounting and the entrance port for locating a width of the blade on the surface zone.

6. The throttle valve as set forth in claim 5 in which the cantilever mounting of the blade comprises a screw having a head and a threaded shank which passes through a hole in the first lengthwise end portion of the blade to tightly engage a threaded hole in the valve body and force the head of the screw to force the first lengthwise end portion of the blade against the surface zone.

7. The throttle valve as set forth in claim 3 in which length of the blade is parallel with the central longitudinal axis.

8. The throttle valve as set forth in claim 1 in which the entrance port slants toward the enclosure in a direction away from the inlet.

9. The throttle valve as set forth in claim 8 in which the exit port slants away from the enclosure in a direction toward the outlet.

10. The throttle valve as set forth in claim 9 in which the exit port comprises a funnel having an open mouth at the surface zone and a narrowing taper which extends away from the surface zone but ends before reaching the main flow passage.

11. The throttle valve as set forth in claim 10 in which a semi-circumference of the narrowing taper of the funnel which is closer to the entrance port comprises a surface area which is smaller than a semi-circumference of the narrowing taper of the funnel which is farther from the entrance port.

12. The throttle valve as set forth in claim 11 in which the open mouth of the funnel circumscribes an area greater at the surface zone than an area circumscribed by the entrance port at the surface zone.

13. The throttle valve as set forth in claim 12 in which the cover has a wall surface that surrounds the semi-circumference of the narrowing taper of the funnel which is farther from the entrance port and that inclines in a direction away from the surface zone to overlie a portion of the open mouth of the funnel.

14. An internal combustion engine comprising:
an intake system comprising an intake manifold and an intake passage through which intake air flows into the intake manifold;
an exhaust system comprising an exhaust manifold and an exhaust passage through which engine exhaust flows from the exhaust manifold;
a throttle valve element which is positionable within a wall which forms a portion of a length of one of the passages to selectively throttle flow through the one passage;
a cover disposed in covering relation to a surface zone on an exterior of the wall and cooperating with the surface zone to form an enclosure, the cover having a continuous perimeter margin sealed to a continuous perimeter margin of the surface zone;
a pressure relief mechanism disposed within the enclosure;
a relief passage having an entrance port from the one passage at a location upstream of where the throttle valve element is throttling flow through the one passage, through the wall and the surface zone, to the enclosure and an exit port from the enclosure, through the surface zone and the wall, to the one passage at a location downstream of where the throttle valve element is throttling flow through one passage;
the pressure relief mechanism further comprising a pressure relief element which is disposed within the enclosure and has a length comprising a first lengthwise end portion and a second lengthwise end portion, the first lengthwise end portion being beyond the entrance port relative to the exit port, and the second lengthwise end portion being closer to the exit port than is the first lengthwise end portion to the exit port; and
a mounting which mounts the first lengthwise end portion of the pressure relief element on the surface zone at a location which associates the second lengthwise end portion of the pressure relief element with the entrance port for controlling flow through the relief passage as a function of pressure differential between pressure in the one passage at the entrance port and pressure in the one passage at the exit port.

15. A pressure relief valve comprising:
a base providing a surface zone having a continuous perimeter margin;
a cover disposed on the base in covering relation to the surface zone to form an enclosure, the cover having a continuous perimeter margin sealed to a continuous perimeter margin of the surface zone;
a relief passage comprising an entrance port extending through the base to the enclosure and an exit port extending from the enclosure through the base;
a pressure relief mechanism disposed within the enclosure and comprising a cantilever-mounted spring steel blade which, when unstressed, assumes a flat, planar shape, and a cantilever mounting of a first lengthwise end portion of the blade at a location which places a second lengthwise end portion of the blade flat against the surface zone to close the entrance port when pressure differential between pressure at the entrance port and pressure at the exit port is less than a pressure differential threshold and cause the blade to flex and open the entrance port when pressure differential between pressure at the entrance port and pressure at the exit port becomes at least as great as the pressure differential threshold.
